(19) United States
(12) Patent Application Publication
(10) Pub. No.: US 2010/0318680 A1
(43) Pub. Date: Dec. 16, 2010

(54) Unified address enhanced locator system and method

(76) Inventors: Isaac S. Daniel, Miami, FL (US); Hortencia Daniel, Miami, FL (US); Katiuska Guerrero, Miami, FL (US); Claudio Schapsis, Plantation, FL (US)

Correspondence Address: Law Offices of Carol N. Green, P.A., 200 S. Biscayne Blvd, Suite 2750, Miami, FL, 33131, US

(21) Appl. No.: 12/456,311

(22) Filed: Jun. 15, 2009

(51) Int. Cl. G06F 15/16

(52) U.S. Cl. 709/245

(57) ABSTRACT

The present invention is directed to a unified address enhanced locator system and method which utilizes an assigned portable address code, which allows individuals to physically locate the geographical location of a home, building, business, landmarks, edifices, and/or set meeting points as well as obtain directions to that geographical location, in townships, neighborhoods, municipalities, cities and/or countries that may or may not employ a formal address scheme with street naming conventions, building numbers, and/or postal codes.

### BACKGROUND OF THE INVENTION

I. Field of the Invention

The present invention is directed to a unified address enhanced locator system and method, which utilizes an assigned portable address code that allows individuals to physically locate a home, building, business, landmarks, edifices, and/or set meeting points as well as obtain directions to a geographical location, in townships, neighborhoods, municipalities, cities and/or countries that may or may not employ a formal address scheme with street naming conventions and building numbers.

II. Prior Art

Several countries, e.g. Costa Rica and Dubai, do not use a formal address scheme as an identifier of the geographical location of a home, building, business, landmark or other edifices (collectively “buildings”). As such, there are no unified street names, building numbers or postal codes to aid in physically locating a building. In these instances, reference points are often used to connote the general direction one must travel to locate an intended destination. For example, in Costa Rica, a building's pseudo “address” may be listed as “Del Spoon San Pedro 50M Este Cuidad: San Jose,” for which the English translation is “50M East from [the building known as] The Spoon, San Jose.” City residents who are familiar with the neighborhood's reference points can easily use the reference points to locate the intended destination. However, visitors and/or new residents who are unfamiliar with the neighborhood will find it challenging to navigate their way around these cities.

Locating buildings and arranging meeting points in these cities are further complicated when a building occupant of a known reference point/landmark relocates, closes and/or vacates the building. Using the prior example, if The Spoon relocated to another location across town, directing others to travel 50M from The Spoon would not only be incorrect but of little value in locating the intended destination. Similarly, directions based on chain establishments, e.g. “Burger King Restaurant,” as a reference point with multiple businesses within a small radius can cause confusion if the requesting party is unaware that multiple establishments exist in the same area with the identical name. Thus, there is a need for a uniformed address system and method wherein individuals can locate buildings, set meeting points in townships, neighborhoods, cities and/or countries that do not employ a formal address scheme using street naming conventions, building numbers, and/or postal codes.

Traveling by taxis is not necessarily the solution to the problem as a taxi driver may be equally unfamiliar with the passenger's destination and/or the neighborhood's reference points. It is not uncommon for a taxi driver to get lost and unintentionally travel a circuitous route to a nearby destination incurring additional costs and unnecessary travel time for the passenger. Thus, there is a need to be able to physically locate buildings and set meeting points based on a universal standard, e.g. a fixed geographical location, in an easy, efficient manner.

The current navigational systems of the prior art allow a user to navigate and locate a point of interest and/or an address based on the user's current location and/or a submitted address. However, there is still room for improvement as there are limited options in providing directions if there are no street names or building numbers as reference points. It is therefore desirable to have a system and method where a user may physically locate a building and/or meeting point(s) using a unified address enhanced locator system and method, for which heretofore there has been no readily useable system and method capable of reliably providing such information for public use, especially in a user friendly and efficient format. This invention satisfies these long felt needs and solves the foregoing limitations of the prior art in a new and novel manner.

### SUMMARY OF THE INVENTION

A primary objective of the invention is to provide a unified address enhanced locator system and method such that the geographical location and directions to a home, building, business, landmarks and or other edifices can be readily determined.

Another objective of the invention is to provide an assigned portable address code that is independent of a fixed geographical location.

Another objective of the invention is to provide a system and method for individuals, businesses, townships, cities, neighborhoods, municipalities, government agencies or any other legal entities to optionally participate in a unified address enhanced locator system and method.

Yet another objective of the invention is to provide a system and method for participating members to customize their own portable address code so that they may be readily located by others.

Still yet another objective of the invention is to provide a system and method for allowing a participating member's assigned portable address code to be correlated to new physical locations, which may differ from the original location that was first registered with the unified address enhanced locator system and method.

Yet another objective of the invention is to provide a system and method for a unified address enhanced locator system and method that users may use to facilitate in-person encounters.

The present invention overcomes the limitations of the prior art by providing a system and method for a unified address enhanced locator, which comprises of receiving a request for participation in a unified address enhanced locator system; receiving address information for a designated entity that corresponds to a geographical location, for the purpose of assigning a new portable address code to the designated entity; assigning a new and unique portable address code to each member's designated entity, wherein the assigned portable address code is capable of being correlated to a geographical location, which may differ from the geographical location previously registered with the unified address enhanced locator system, and from which directions to the member's designated entity may be derived; registering and storing the portable address code; and publishing, i.e. disclosing, the portable address code to at least one party, which may include any one or more of the following: a user, the owner of the assigned portable address code, another person, other participating member(s), a corporate entity, a government agency, municipality and/or any other user or party accessing the unified address enhanced locator system.

The address information may include but is not limited to any one or more of the following: a person's name, name of corporate entity, building name, building alias(es), street name, street alias(es), floor number, suite number, room number, city, location information relative to at least one other known landmark, an absolute geographical location, post office, postal code, township, neighborhood, county, province, country, and/or any other pertinent address information that is well known and used in the arts. A designated entity includes but is not limited to: a residence, building, building description, name of a corporate entity, landmark, governmental agencies, municipality, municipal buildings and/or any other designated entities for accommodating and/or sheltering people, business or agencies that are well known and used in the arts. A corporate entity may include but is not limited to any one or more of the following: partnership, corporation, sole proprietorship, individuals doing business as a corporate entity, associations, professional associations, limited liability company, limited liability partnership, a not for profit entity, a for profit entity, an agency, and/or an organization as well as any other legally permissible designations for corporate entities that are well known and used in the arts.

The assigned portable address code may be any one or more of the following: temporary, semi-permanent or permanent and may comprise of any one or more of the following singly or in combination: numbers, characters, alphabets, alphanumeric characters, drawings, or any other designations that maybe used to designate a unique identifier that is well known and used in the arts.

With this invention, when a participating member relocates its designated entity to a new physical location, the portable address code may be correlated to the new physical location remaining independent of a fixed geographical location. The participating member simply updates the unified address enhanced locator system and method with the new physical location for the assigned portable address code and the system will update its records accordingly. As such, participation in this invention is cost effective as some of the costs associated with relocating expenses, e.g. updating marketing materials, business cards, stationary, etc., with new address information are defrayed, if not eliminated. Since the assigned portable address code remains the same despite changes to the physical location(s), a participating member may retain their assigned portable address code for as long as they prefer even if they relocate several times over the years.

Corporate entities and/or any other participating member may take advantage of this feature and customize their assigned portable address code to aid in branding and helping others to readily locate their business or geographical location. For example a law firm, “AA Law Associates,” may request a customized portable address code of AALAW-713791, for which the system and method assigns a customized portable address code to the participating member's designated entity, i.e. the law firm, which may be correlated to any physical location that AA Law Associates chooses to house its law firm. AA Law Associates may then publish its location to the public in marketing materials, advertising brochures, web pages, etc. as “AA Law Associates—Located at AALAW-713791.”

This invention may also be used by both participating and non-participating members to obtain directions to or from a physical location, which may or may not be assigned a portable address code. As such, a new user requesting directions to a physical location using the invention will first need access to the system and method of the invention. The new user may submit a request for access and the system and method of the invention receives the request for access to the unified address enhanced locator system; provides access to the unified address enhanced locator system; receive a request to locate a point of interest based on a user's submitted location; determine if the point of interest is an assigned portable address code and if so, the system and method of the invention translates the portable address code to a physical geographical location by converting the portable address code into latitude and longitude coordinates.

If the point of interest for which directions are being requested is not an assigned portable address code, the system and method of the invention generate navigational directions to or from the point of interest; and publishing map and navigational directions to or from the point of interest to at least one party using the assigned portable address code for at least one member's designated entity as one of the reference points from which directions may be derived. The navigational directions may include any one or more of the following solely or in combination: step by step directions, text, map, graphs, voice commands, singly or in combination, and/or any other graphical display that are well known and used in the arts. The navigational directions may be published to the user requesting the directions, the owner of the assigned portable address code, another person, other participating member(s), a corporate entity, municipality, a government agency and/or any other user or party accessing the unified address enhanced locator system.

The point of interest may include but is not limited to any one or more of the following: name of a building, landmark, an assigned portable address code, a residence, a corporate entity, governmental building, governmental agency, an absolute geographical location, location information relative to at least one known landmark, post office box, postal code, town, street name, neighborhood, city, township, province, another member's designated entity or any other point of interest for which a geographical location may be found. The user's submitted location may include any one or more of the following: current geographical location, name of a building, landmark, an assigned portable address code, a residence, a corporate entity, governmental building, governmental agency, an absolute geographical location, location information relative to at least one known landmark, post office box, postal code, town, street name, neighborhood, city, township, province, another member's designated entity or any other submitted location from which directions may be derived to and therefrom.

The system and method of the invention may provide access to users by providing downloadable software via a user interface to the user's cellular phones, e.g. I-Phone, Andriod, Symbian, etc., personal digital assistants (“PDA”), computer laptop, and/or other wireless LAN (“WLAN”) communication devices that are well known and used in the arts. It is understood that some WLAN devices may also access the system of the invention without requiring downloadable software, i.e. Software as a Service (“SaaS”).

Additional objectives of the present invention will appear as the description proceeds.

The foregoing and other objects and advantages will appear from the description to follow. In the description, references are made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1 is a sample flowchart of a method of providing a portable address code according to an embodiment of the present invention.

FIG. 2 is a sample flowchart of an exemplary method of providing directions using the unified address enhanced locator system according to an embodiment of the present invention.

FIG. 3 is a sample network diagram illustrative of an exemplary embodiment of the system of the invention.

### DETAILED DESCRIPTION OF THE PREFERRED EMBODIMENT

The following discussion describes in detail an embodiment of the unified address enhanced locator (and variations of that embodiment). However, this discussion should not be construed, as limiting the invention to those particular embodiments, as practitioners skilled in the art will recognize numerous other embodiments as well. For definition of the complete scope of the invention, the reader is directed to the appended claims. Turning now descriptively to the drawings, in which similar reference characters denote similar elements throughout the several views.

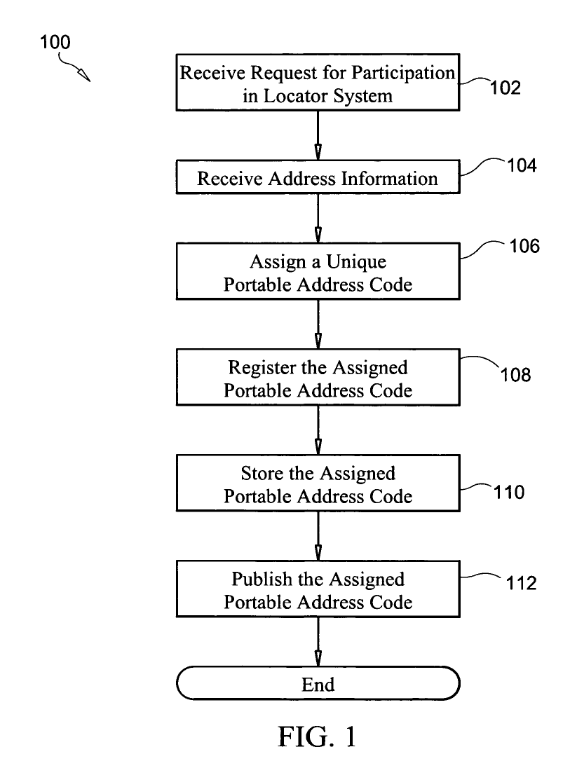

FIG. 1 is a sample flowchart of a method 100 of providing a portable address code 10 (not shown) according to an embodiment of the present invention. Any owner, renter or lessee of a building, government agencies, municipalities, townships, neighborhoods, cities, counties, countries and/or any other legal entity may participate in the unified address enhanced locator system 12 and method 100. In accordance with the present invention, the system 12 receives a request for participation in the unified address enhanced locator system 12 as seen in step 102. Membership participation may be provided free of cost, for a fee and/or including costs associated with renewals, annual fees, reactivation fees, updated maps, etc., as well as any other fees that are well known and customarily used in arts in e-commerce applications. The system 12 will require pertinent address information 14 (not shown) from the potential member, which may be used to verify and/or confirm the authenticity of the request. The address information 14 (not shown) may include but is not limited to: a person's name, name of corporate entity 16 (not shown), building name, building alias(es), street name, street alias(es), floor number, suite number, room number, city, location information 18 (not shown) relative to at least one other known landmark, an absolute geographical location 20 (not shown), post office, postal code, township, neighborhood, county, province, country or any other pertinent address information 14 (not shown) that is well known and used in the arts.

The system 12 receives the address information 14 (not shown) (step 104) for a designated entity 22 (not shown) that corresponds to a fixed geographical location 20 (not shown), for the purpose of assigning a new portable address code 10 (not shown) for the designated entity 22 (not shown). The designated entity 22 (not shown) includes but is not limited to: a residence, building, building description, name of a corporate entity 16 (not shown), landmark, governmental agencies, municipality, municipal buildings and/or any other designated entities 22, 22′ (not shown) for housing or sheltering people, business and/or agencies that are well known and used in the arts. A corporate entity 16 (not shown) may include but is not limited to any one or more of the following: partnership, corporation, sole proprietorship, individuals doing business as a corporate entity 16 (not shown), associations, professional associations, limited liability company, limited liability partnership, not for profit entity, for profit entity, an agency, or an organization as well as any other legally permissible designations for corporate entities 16, 16′ (not shown) that are well known and used in the arts.

In one embodiment of the invention, the system 12 may verify the address information 14 (not shown) provided by the potential member for accuracy (step 103, not shown) prior to assigning a portable address code 10 (not shown) to the member's designated entity 22 (not shown). Nevertheless, the system 12 assigns a new and unique portable address code 10 (not shown) as in step 106 to each member's designated entity 22 (not shown), where the assigned portable address code 10 (not shown) is capable of being correlated to any other geographical location 20 (not shown) of choice, which may differ from the geographical location 20 (not shown) previously registered with the unified address enhanced locator system 12, and from which directions 24 (not shown) to and from the participating member's designated entity 22 (not shown) may be derived therefrom. As such, any owner, renter or lessee of a building, government agencies, municipalities, townships, neighborhoods, cities, counties, countries and/or any other legal entity may participate as a member of the unified address enhanced locator system 12 and method 100 and obtain a unique portable address code 10 (not shown) for a residence, corporate entity 16 (not shown), buildings, and/or other landmarks, e.g. Blue Hills.

Once the portable address code 10 (not shown) has been assigned, the system 12 registers the assigned portable address code 10 (not shown) (step 108) and stores at least one assigned portable address code 10 (not shown) (step 110) with a memory device 26, e.g. an electronic database, of the invention. The system 12 may thereafter publish the assigned portable address code 10 (not shown) (step 112) to at least one party, which may include any one or more of the following: a user, the owner of the newly assigned unique portable address code 10 (not shown), another person, other participating member(s), a corporate entity 16 (not shown), a municipality, government agency and/or any other user or party accessing the unified address enhanced locator system 12.

The assigned portable address code 10 (not shown) may be any one or more of the following: temporary, semi-permanent or permanent, and may comprise of any one or more of the following singly or in combination: numbers, characters, alphabets, alphanumeric characters, drawings, or any other characters or combination thereof that are well known and used in the arts to a assign a unique code for a plurality of users. If a participating member relocates its designated entity 22 (not shown) to a new physical location 30 (not shown), the assigned portable address code 10 (not shown) may be correlated to the new physical location 30 (not shown) remaining independent of a fixed geographical location 20 (not shown). Thus, a participating member may retain his/her assigned portable address code 10 (not shown) for as long as desired, publishing its address in advertising brochures, web pages, etc. Thereafter, when a user requests directions 24 (not shown) to the member's designated entity 22 (not shown), the user will be routed to the most current geographical location 20 (not shown) for the member's designated entity 22 (not shown) that has been provided to, and/or stored with the system 12. It would therefore be beneficial for each member to ensure that the system 12 has the most current and updated address information 14 (not shown) for the member's designated entity 22 (not shown).

Participating members may submit requests for customized portable address codes 10, 10′ (not shown) for their designated entities 22, 22′ (not shown), which may be used as an enhanced locator 28 (not shown) for its goods and services. The system 12 and method 100 may assign a customized portable address code 10 (not shown) to a participating member's designated entity 22 (not shown) upon receipt of a request from the member. For example the law firm, “AA Law Associates,” may request a customized assigned portable address code 10 (not shown) of e.g. “AALAW-713791,” which may be published to the general public as “AA Law Associates, Located at AALAW-713791.” If AA Law Associates moves to a new physical location 30 (not shown), i.e. site, the customized assigned portable address code 10 (not shown) may be correlated to the new physical location 30 (not shown), where the relocation will appear seamless to third parties who will be directed to AALAW-713791. In this manner, the portable address code 10 (not shown) is independent of a fixed geographical location 20 (not shown).

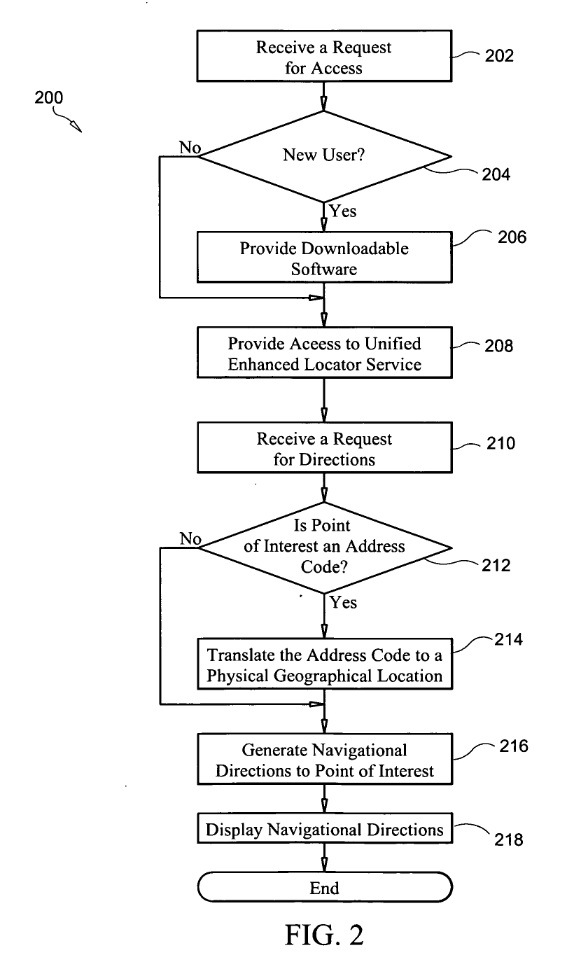

FIG. 2 is a sample flowchart of an exemplary method 200 of providing directions 24 (not shown) using the unified address enhanced locator system 12 according to an embodiment of the present invention. Users of the unified address enhanced locator system 12 desiring directions 24 (not shown) to a point of interest 32 (not shown) will first need access to the system 12 of the invention. The user may submit a request where the system 12 receives the request for access (step 202) to the unified enhanced address locator system 12 and determines whether the user is a new user (step 204) which may require providing downloadable software (step 206) to his or her WLAN device 34, and/or any other mobile operating systems 36 (collectively “WLAN device 34”) that is being used to access the system. It is understood that once the software has been downloaded, the user may access the system 12 for information, e.g. request directions to a point of interest 32 (not shown), via a user interface 38 (not shown) at will without having to re-download the software. It is understood that some WLAN devices 34, 34″ may also access the system 12 of the invention without requiring downloadable software, i.e. Software as a Service (“SaaS”). However, periodic updates may be required or alternatively the updates may be transparent to the user. Use of the system 12, may require a fee or alternatively it may be free or some combination thereof similar to like e-commerce applications where certain services are free while others are provided at a cost.

If the user is a prior user, the system 12 skips step 206 and proceeds directly to step 208 to provide access to the unified enhanced locator system 12 via a user interface 38 (not shown). The user may then request directions 24 (not shown) providing a submitted location 40 (not shown) which may include but is not limited to any one or more of the following: current geographical location 20 (not shown), name of a building, a landmark, an assigned portable address code 10 (not shown), an absolute geographical location 20 (not shown), location information 18 (not shown) relative to at least one known landmark, corporate entity 16 (not shown), another member's designated entity 22 (not shown), a residence, governmental building, governmental agency, post office box, postal code, town, street name, neighborhood, city, township, province, and/or or any other naming conventions that are well known and used in the arts to identify buildings, edifices and/or structures as well as any other location information 18 (not shown) from which directions 24 (not shown) may be derived to and therefrom.

The system 12 receives the request for directions 24 (not shown) (step 210) to a point of interest 32 (not shown) based on the user's submitted location 40 (not shown). The point of interest 32 (not shown) may include but is not limited to any one or more of the following: name of a building, a landmark, an assigned portable address code 10 (not shown), an absolute geographical location 20 (not shown), location information 18 (not shown) relative to at least one known landmark, corporate entity 16 (not shown), another member's designated entity 22 (not shown), a residence, governmental building, governmental agency, post office box, postal code, town, street name, neighborhood, city, township, province, and/or or any other naming conventions that are well known and used in the arts to identify buildings, edifices and/or structures as well as any other location(s) from which directions may be derived to and therefrom.

In deriving the directions 24 (not shown) the system 12 will determine whether the point of interest 32 (not shown) is a portable address code 10 (not shown) (step 212). If the point of interest 32 as inputted to the system 12 is a portable address code 10 (not shown), the system 12 translates the portable address code 10 (not shown) to a physical geographical location 20 (not shown) (step 214) by converting the portable address code 10 (not shown) into latitude and longitude coordinates. If however, the point of interest 32 was not a portable address code 10 (not shown) but comprised of a search by name, corporate entity 16 (not shown), type of business, landmark, etc, then the system 12 generates navigational directions 24 (not shown) to the point of interest 32 (step 216), which may include one or more participating member's portable address codes 10, 10′, 10″ as reference points 42, 42′, 42″ (not shown) from which directions 24 (not shown) may be derived. The system 12 may display the navigational directions 24 (not shown) (step 218) to or from the point of interest 32 in a format that is readily understood by the user, e.g. as text, geographical display, map and/or any combination thereof as well as any other format that is well known and used in the arts.

In certain embodiments of the invention, the user may have used a WLAN device 34 to request directions 24 (not shown) from the system 12, wherein the WLAN device 34 may have location determining capabilities employing GPS technology used to determine the geographical location 20 (not shown) of the WLAN device 34, and by extension the user. As such, the system 12 may use the latitude and longitude coordinates of that geographical location 20 (not shown) obtained from the WLAN device 34 to derive directions 24 (not shown) to or from the requested point of interest 32 (not shown).

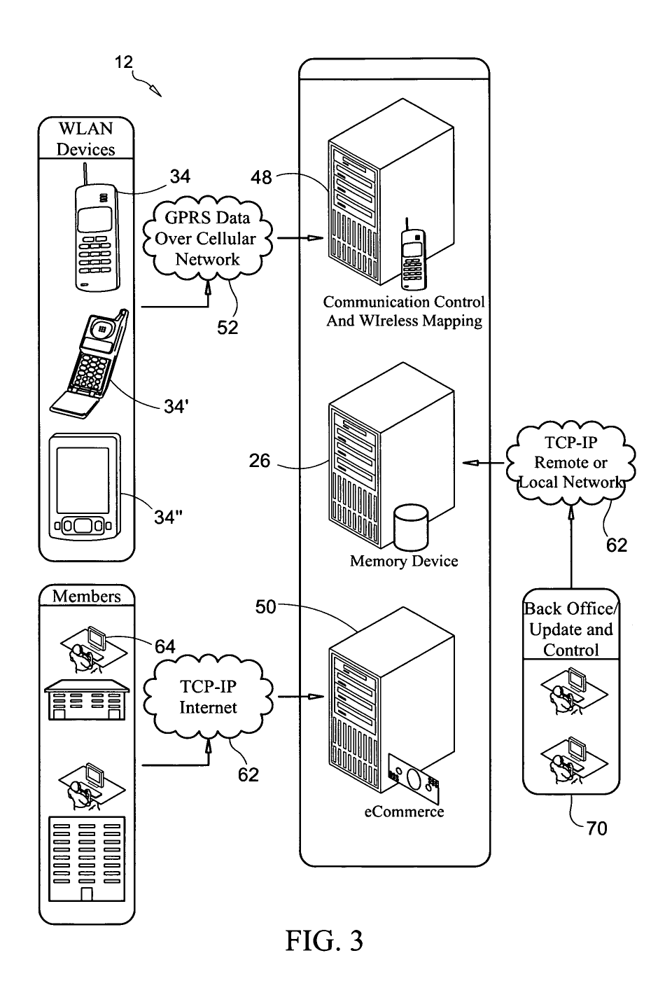

FIG. 3 is a network diagram illustrative of an exemplary embodiment of the system 12 of the invention. The system 12 comprises of a memory device 26 and at least one central processor 46 (not shown), disposed in communication with the memory device 26, wherein the central processor 46 (not shown) includes instructional code and is configured to perform the various functions of the system 12 of the invention. For example, the central processor 46 (not shown) is configured to provide users with access to the system 12, register and store members′ information, generate and assign portable address codes 10, 10′ (not shown), generate and publish directions 24 (not shown), display navigational steps to and from a point of interest 32 (not shown) as well as any other necessary functions that a conventional system 12 will require as are well known and used in the arts.

Illustratively, the two servers i.e. the communications control and wireless mapping server 48, and the eCommerce server 50, as well as the memory device 26 are illustrated as three separate components of the system 12. However, it is understood by those skilled in the arts that all three system 12 components may alternatively have been combined into a single unitary system 12, capable of performing each of the three illustrated functions, i.e. the communications control and wireless mapping function, managing the e-commerce functions and the storage functions of a memory device 26.

As previously discussed a user may use various WLAN devices 34, 34′, 34″ to communicate with the system 12, e.g. to register as a member, request directions 24 (not shown), and/or any other functions that are well known and used in the arts. The user interface 44 (not shown) may be customized for the specific WLAN devices 34, 34′, 34″ as they communicate with the communications control and wireless mapping server 48 exchanging Global Packet Radio Service (“GPRS”) data 52 over a cellular network 54 (not shown) or any other wireless data format that is well known and used in the arts. The communications control and wireless mapping server 48 manages the flow of information to and from the user, managing user requests for such services as registrations, updates, requests for customized portable access codes 10, 10′ (not shown), directions 24 (not shown) to or from a portable address code 10 (not shown), as well as any other mapping and control functions of the system 12 of the invention.

When a user requests directions 24 (not shown) and provides for example, a portable address code 10 (not shown) to the system 12, the communications control and wireless mapping server 48 receives the portable address code 10 (not shown) and accesses the memory device 26 to identify and locate the portable access code 10 (not shown). Once the portable access code 10 (not shown) is located, the communications control and wireless mapping server 48 translates the portable address code 10 (not shown) to a fixed geographical location 20 (not shown), i.e. providing longitude and latitude coordinates, and generates navigational directions 24 (not shown) which may include a step by step directions that are returned to the user in a user friendly format, i.e. as text, a map, map and text, graph, voice commands and/or any other graphical display 56 (not shown) of the directions 24 (not shown) that are well known and used in the arts to the user.

As illustrated, the communications control and wireless mapping server 48 as well as the e-Commerce server 50 of the invention each comprises of an operating system 58 (not shown) and a central processor 46 (not shown) (not shown) in communication with the memory device 26, which uses an electronic database 58 (not shown) to store information concerning each participating member and the various portable address codes 10, 10′, 10″ (not shown). It is understood that the memory device 26 may comprise of any computer-readable storage media devices, e.g. a CD-ROM, flash drives, electronic database 58 (not shown) and/or any other storage media devices that are well known and used in the arts. The memory device 26 may also include instruction code for implementing and supporting the system 12 and the various methods of the unified address enhanced locator system 12. The stored information may include but is not limited to the participating member's portable address code(s) 10, 10′ (not shown), location information 18 (not shown), geographical locations 20, 20′, 20″, membership information 60 (not shown), which may include member's name, contact information, membership status as in active or inactive, address information 14 (not shown), etc.

The central processors 46, 46′ (not shown) of the communications control and wireless mapping server 48 and e-Commerce server 50 include instruction code, and are configured to implement and support the system 12 and the various methods 100, 200 of the unified address enhanced locator system 12, which may include but is not limited to receiving and storing data, receiving requests form users, performing searches, assigning portable address codes 10, 10′ (not shown), translating portable address codes 10, 10′ (not shown) to fixed geographical location 20 (not shown), generating and publishing directions 24 (not shown) and or portable address codes 10, 10′ (not shown), as well as any other system functions that are required to implement the invention.

Participating members may access and communicate with the system 12 of the invention, e.g. the e-Commerce server 50 via Internet protocol 62, such as TCP-IP using their web access device e.g. cellular phones, i.e. I-Phones, BlackBerry®, smart phones, or a WLAN device 34, e.g. PDAs, or personal computer 64 with a keyboard 66, 66′ (not shown) and monitor 68, 68″ (not shown) for entering and displaying information. The participating member may access the system 12 to perform conventional e-commerce activities that are well known and used in the arts, e.g. register with the system 12, make payments for membership fees, renewal fees, receive updates, make payments for customized assigned portable address codes 10, 10′ (not shown), etc. Also, one skilled in the art will appreciate that various communication channels may be used to interconnect the system 12 via the Internet protocol 62 with the users′ personal computer 64 such as a wide area network, or point-to-point, dial-up connections, cable network, fiberoptics, and DSL high speed connections or any other communications means that are well known and used in the arts.

The system 18 will require the creation and maintenance of the main electronic database 58 (not shown) to register and store the various names or designations for residences, buildings, corporate names, corporate entities 16 (not shown), landmarks, edifices, points of interests 32, 32′ (not shown), aliases, location information 18 (not shown) relative to at least one other known landmark, absolute geographical locations 20, 20′ (not shown) of various landmarks, post office boxes, postal codes, townships, neighborhoods, floor locations, room locations, street names, assigned portable access codes 10, 10′ (not shown) as well as any other relevant address information 14 or location information 18 to be either programmed in or manually inputted into the electronic database 58 (not shown). The inputting process is a function of the back office 70, which will either input the entries and/or updates manually, or program the servers 48, 50 to automatically do so. The back office 70 may access and/or communicate with the servers 48, 50 using TCP-IP communications protocol 62 via remote or local area network systems, or any other Internet protocol 62 that are well known and used in the arts.

While the invention has been described in connection with specific embodiments and applications, the inventor does not intend to restrict the description to the examples shown. Persons skilled in the art will recognize that the above system 12 and methods 100, 200 may be modified or changed without departing from the general scope of the present description, the intention of the inventor being to include all such modifications and alterations in so far as they come within the scope of the appended claims or the equivalents thereof.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms, method, steps and system illustrated and in its operation can be made by those skilled in the art without departing in any way from the spirit of the present invention.

What is claimed is:

1. A method of providing a portable address code comprising:
(a) receiving a request for participation in a unified address enhanced locator system;
(b) receiving address information for a designated entity that corresponds to a geographical location, for the purpose of assigning a new portable address code to the designated entity;
(c) assigning a unique portable address code to each member's designated entity, wherein the assigned portable address code is capable of being correlated to a geographical location, which may differ from the geographical location previously registered with the unified address enhanced locator system, and from which directions to and from the member's designated entity may be derived;
(d) registering and storing the portable address code; and
(e) publishing the portable address code to at least one party.

2. The method of claim 1, wherein the address information may include but is not limited to any one or more of the following: a person's name, name of corporate entity, building name, building alias(es), street name, street alias(es), floor number, suite number, room number, city, location information relative to at least one other known landmark, an absolute geographical location, post office, postal code, township, neighborhood, county, province or country.

3. The method of claim 2, wherein the corporate entity includes any one or more of the following: partnership, corporation, sole proprietorship, individuals doing business as a corporate entity, associations, professional associations, limited liability company, limited liability partnership, a not for profit entity, a for profit entity, an agency, or an organization.

4. The method of claim 1, wherein the designated entity includes but is not limited to: a residence, building, building description, name of a corporate entity, landmark, governmental agencies, municipality and municipal buildings.

5. The method of claim 1, wherein the portable address code may be any one of the following: temporary, semi-permanent or permanent.

6. The method of claim 1, wherein the portable address code may comprise of any one or more of the following: numbers, characters, alphabets, alphanumeric characters, or drawings.

7. The method of claim 1, wherein the portable address code may be correlated to a new physical location remaining independent of a fixed geographical location.

8. The method of claim 1, further comprising: assigning a customized portable address code to said designated entity upon receipt of a request from a member.

9. The method of claim 1, wherein publishing the portable address code to at least one other includes but is not limited to any one or more of the following: a user, an owner of the assigned portable address code, another person, other participating member(s), a corporate entity, a municipality, or government agency.

10. A method of providing directions comprising:
(a) receiving a request for access to a unified address enhanced locator system;
(b) providing access to the unified address enhanced locator system;
(c) receiving a request to locate a point of interest based on a user's submitted location;
(d) determining if the point of interest is an assigned portable address code;
(e) generating navigational directions to or from the point of interest; and
(f) publishing navigational directions to or from the point of interest to at least one party using the assigned portable address code for at least one member's designated entity as one of the reference points from which directions may be derived.

11. The method of claim 10, wherein said determining comprises of: translating said portable address code to a physical geographical location by converting the portable address code into latitude and longitude coordinates.

12. The method of claim 10, wherein the point of interest may include any one or more of the following: name of a building, landmark, an assigned portable address code, a residence, a corporate entity, governmental building, governmental agency, an absolute geographical location, location information relative to at least one known landmark, post office box, postal code, town, street name, neighborhood, city, township, province, another member's designated entity.

13. The method of claim 10, wherein the user's submitted location may include any one or more of the following: current geographical location, name of a building, a landmark, an assigned portable address code, an absolute geographical location, location information relative to at least one known landmark, corporate entity, another member's designated entity, a residence, governmental building, governmental agency, post office box, postal code, town, street name, neighborhood, city, township, province.

14. The method of claim 10, wherein providing access to the unified address enhanced locator system includes providing downloadable software via a user interface.

15. The method of claim 10, wherein said navigational directions may include any one or more of the following: step by step directions, text, map, graphs, voice commands.

16. A system of unified address enhanced locator comprising:
(a) a memory device; and
(b) a processor disposed in communication with the memory device, the processor configured to:
(i) receive a request for participation in a unified address enhanced locator system;
(ii) receive address information for a designated entity that corresponds to a geographical location, for the purpose of assigning a new portable address code to the designated entity;
(iii) assign a unique portable address code to each member's designated entity, wherein the assigned portable address code is capable of being correlated to a geographical location which may differ from the geographical location previously registered with the unified address enhanced locator system, and from which directions to and from the member's designated entity may be derived;
(iv) register and store the portable address code; and
(v) publish the portable address code to at least one party.

17. The system of claim 16, wherein the address information may include but is not limited to any one or more of the following: a person's name, name of corporate entity, building name, building alias(es), street name, street alias(es), floor number, suite number, room number, city, location information relative to at least one other known landmark, an absolute geographical location, post office, postal code, township, neighborhood, county, province or country.

18. The system of claim 17, wherein the corporate entity includes any one or more of the following: partnership, corporation, sole proprietorship, individuals doing business as a corporate entity, associations, professional associations, limited liability company, limited liability partnership, a not for profit entity, a for profit entity, an agency, or an organization.

19. The system of claim 16, wherein the designated entity includes but is not limited to: a residence, building, building description, name of a corporate entity, landmark, governmental agencies, municipality and municipal buildings.

20. The system of claim 16, wherein the portable address code may be any one of the following: temporary, semi-permanent or permanent.

21. The system of claim 16, wherein the portable address code may comprise of any one or more of the following: numbers, characters, alphabets, alphanumeric characters, or drawings.

22. The system of claim 16, wherein the portable address code may be correlated to a new physical location remaining independent of a fixed geographical location.

23. The system of claim 16, further comprising:
(a) a memory device; and
(b) a processor disposed in communication with the memory device, the processor configured to:
(i) assign a customized portable address code to said designated entity upon receipt of a request from said member.

24. The system of claim 16, wherein publishing the portable address code to at least one other party includes but is not limited to any one or more of the following: a user, an owner of the assigned portable address code, another person, other participating member(s), a corporate entity, a municipality, or government agency.

25. A system of providing directions comprising:
(a) a memory device; and
(c) a processor disposed in communication with the memory device, the processor configured to:
(i) receive a request for access to a unified address enhanced locator system;
(ii) provide access to the unified address enhanced locator system;
(iii) receive a request to locate a point of interest based on a user's submitted location;
(iv) determine if the point of interest is an assigned portable address code;
(v) generate navigational directions to or from the point of interest; and
(vi) publishing navigational directions to or from the point of interest to at least one party using the assigned portable address code for at least one member's designated entity as one of the reference points from which directions may be derived.

26. The system of claim 25, further comprising:
(a) a memory device; and
(b) a processor disposed in communication with the memory device, the processor configured to:
(i) translate said portable address code to a physical geographical location by converting the portable address code into latitude and longitude coordinates.

27. The system of claim 25, wherein the point of interest may include any one or more of the following: name of a building, landmark, an assigned portable address code, a residence, a corporate entity, governmental building, governmental agency, an absolute geographical location, location information relative to at least one known landmark, post office box, postal code, town, street name, neighborhood, city, township, province, another member's designated entity.

28. The system of claim 25, wherein the user's submitted location may include any one or more of the following: current geographical location, name of a building, a landmark, an assigned portable address code, an absolute geographical location, location information relative to at least one known landmark, corporate entity, another member's designated entity, a residence, governmental building, governmental agency, post office box, postal code, town, street name, neighborhood, city, township, province.

29. The system of claim 25, further comprising:
(a) a memory device; and
(b) a processor disposed in communication with the memory device, the processor configured to:
(i) provide access to the unified address enhanced locator system includes providing downloading software via a user interface.

30. The system of claim 25, wherein said navigational directions may include any one or more of the following: step by step directions, text, map, graphs, voice commands.
